(19) United States
(12) Patent Application Publication
(10) Pub. No.: US 2010/0212960 A1
(43) Pub. Date: Aug. 26, 2010

(54) Method for optimizing the prediction and assessment of earthquakes and/or seismic vibrations

(76) Inventors: Joachim Loos, Herten (DE); Wilhelm Ehrhardt, Bochum (DE)

Correspondence Address: JAMES C. WRAY, 1493 CHAIN BRIDGE ROAD, SUITE 300, MCLEAN, VA, 22101, US

(21) Appl. No.: 12/660,049

(22) Filed: Feb. 19, 2010

(30) Foreign Application Priority Data
Feb. 26, 2009 (DE) 10 2009 010 751.7

(51) Int. Cl. E21B 7/00; G01V 1/00; G06F 19/00

(52) U.S. Cl. 175/2; 702/15

(57) ABSTRACT

The scales that allow for the shear planes (first scale), the rock and/or crust geometry (second scale), and the change of the geometries as earthquake systematics (third scale) are the basis for prediction and reduction of intensity. Actions to generate mini-movements to reduce the intensity of earthquakes are then concentrated on those areas where the stress concentrations generate jerky movements to alter the rock geometry (third scale). Based on the scale, the large-scale areas that influence the local stress concentrations and are involved in the jerky movements are thus taken into consideration.

A method for optimizing the prediction and assessment of earthquakes and/or seismic vibrations.

According to the present level of knowledge, 90% of earthquakes are tectonic or displacement quakes. Subsidence earthquakes in connection with subterranean cavities account for 3%, while 7% are caused by volcanic activity. The method relates to tectonic and/or displacement quakes. Furthermore, according to the present level of knowledge, 85% are so-called shallow quakes, meaning quakes down to 70 km. These are quakes within the Earth's crust.

Subsidence earthquakes are not a component of this application. These quakes include rock bursts that are commonly known in mining. Please refer to

Patent DE 196 28 367 and others by the same authors. Rock bursts are sudden releases in rocks that trigger rock movements.

Stress release actions are dependent upon bore hole technologies. In this regard, drilling to a depth of 15 km is possible. Areas of up to approximately 20 km are covered if the effective radius of nuclear explosions is included.

The so-called Richter scale is a measure used to determine the severity of earthquakes. The higher the value is, the greater the effects are, in particular, at the ground surface. With respect to damages, it is very important that the Richter scale value be low. That means that reduced values translate into a lower intensity earthquake. The damage becomes increasingly less significant.

Displacement quakes are jerky stress reductions in rock where stresses are removed by means of rock movements (dislocations). Stress arises from the geopressure, which is a synonym for the pressure of the Earth's crust and the geo-counterpressure, where the geopressure overcomes the geo-counterpressure all at once. Therefore, the described geo-counterpressure that does not overcome the geopressure is of great importance for the onset of earthquakes and/or seismic vibrations.

The geopressure and the resistance (geo-counterpressure) that the rock exerts against a reduction of the geopressure are also decisive for the severity of an earthquake. An increased resistance means a greater likelihood of onset of dangerous stress concentrations, whose sudden transformation into movement processes will trigger said earthquakes. That is, the point is to minimize the resistance to a reduction of the geopressure. In this way the geopressure and/or the geopressure variations are minimized. This occurs in connection with the geometric structures, including existing structural changes of strikes and dips and amounts of normal fault, thrust fault, and displacement, and the interdependence of the tectonic elements.

Most earthquakes are associated with plate tectonics. There are two types of associations. The differences come from the fact that either oceanic plates and continental plates or two continental plates trigger the earthquakes. According to the present level of knowledge, oceanic plates move at a speed of 5 cm per year, while continental plates move at about half that speed. The oceanic and continental plates primarily generate earthquakes at the margins of the large continents, while in the Mediterranean region, for example, two continental plates push against one another. Geopressure and geo-counterpressure and their differences are in both cases effective influences.

With respect to overcoming the geo-counterpressure exerted by the mass of the rock by means of jerky movements, it is of considerable importance that the static friction be greater than the dynamic friction. This causes jerky movements at the interfaces of the rock (displacements, thrust faults, and normal faults). The earthquake intensity generally increases with the increase in distance traveled in one jolt, and/or with the increasing sudden yield of geo-counterpressure. That means that the earthquake intensity decreases when larger jerky movements are reduced to smaller movements through relaxation measures.

These natural stress release measures loosen the rock. They increase the movement capacity of partial areas of rock and at the same time ensure that fluids reduce static friction of the tectonic elements such as displacements, thrust faults, and normal faults. The intrusion of water into the gaps of tectonic elements brings about a reduction in friction forces. The earthquake intensity is thus reduced by triggering a plurality of smaller earthquakes.

The Earth's crust has a rock geometry that is characterized by interfaces (displacements, thrust faults, normal faults, and fold axes). The behavior of said interfaces varies. This applies to strike directions, dips, and faulting. These circumstances influence the effects of geopressure and geo-counterpressure, as well as their variations within the rock geometry. Thus, there is a direct correlation with the change of geometric structures of the rock. In other words, the geometric structures are a component used for determining geopressure differences. This in turn means that the geometric structures of the Earth's crust allow us to draw conclusions regarding the possibility of reducing the earthquake intensity by means of stress release measures. And this creates the basis for technical measures such as orienting the stress release drilling and the strength of the necessary artificial vibrations.

The above applies to the merging of rock masses that in aggregate are the starting point for seismic vibrations. Here it is a prerequisite that the geo-counterpressure supplied by the mass of the rock and/or crust components is not overcome for some time with respect to said group. There is little freedom of movement downward, upward, or sideways, which can be determined from the rock geometry.

The above also applies to determination of continuous and/or discontinuous increases and/or decreases in geopressure.

The object of the present invention is early detection of stresses that tend to lead to catastrophic reductions (earthquakes), and their transformation into jerky, mostly harmless stresses.

In the earth sciences, to date primary interest has been on cross sections and bedding planes that characterize the rock geometry. This includes stratigraphic and petrographic interests.

Variations in rock geometry approach the infinite if the already present changes of the strike, dip, and the rates of normal fault, thrust fault, and displacement, and the interdependence of the tectonic elements as well as their changes are included in the variations. This complexity has thus far impeded the establishment of correlations between rock geometry and earthquakes, for earthquakes develop when changes occur in any of the manifold rock geometries.

Patent DE 196 28 367 nullifies the above. It is significant that rock bursts and earthquakes have their origin in stress concentrations, which are resolved more or less instantly.

Building on Patent DE 196 28 367, among others, regions subject to diverse tectomechanical stresses and their differences are the basis for determining stress concentrations. These horizontal and vertical differences arise owing to geopressure and geo-counterpressure and their differences. They are influenced by blocked movement and free movement zones for material movements inside the rock. They are then contributing factors for the onset or absence of movements by which the stress concentrations are reduced and/or energy is transformed. The basis for this is the collaboration of tectonic elements and their changes.

The closeness of earthquakes to rock bursts in mining also stems from the fact that in both cases sudden movements and/or displacements are caused. This occurs when geopressure and geopressure variations provoke movements in the rock, which is categorized by the term “tectomechanical stress.”

Mining also causes movements in rock. For mining, this means that computational methods have been determined on a recognized scientific basis, by which the movements in the rock and at the ground surface could be calculated in advance. This has to do with so-called subsidence damage prevention. The calculations take into account that subsidence as well as uplift occurs. Subsidence slopes and bends are derived from these. Additionally, swelling and stretching as well as displacement, compression, and distraction are present. These facts were used to deduce influences of geopressure on mining, as well as natural gas and water extraction. The mining-relevant technologies affected by this include optimal positioning of extraction facilities, the optimal extraction direction, and attainable extraction rates. In addition there are indications of the economically extractable mineral reserve. Gas and water circulation, the fragility and/or bursting tendency of the rock, as well as the stress concentrations and their release by rock bursts must also be mentioned. The geopressure determines the use of optimal technologies.

Further, the closeness of earthquakes and/or seismic vibrations to rock bursts in mining is based on the fact that the boundaries of the individually stressed rock masses defined by geopressure and/or geopressure variations promote the onset or occurrence of rock bursts and/or of seismic vibrations. The boundaries of mining regions also have these characteristics. In this comparison it is significant that the geopressure and the geopressure differences can produce more intensely sheared areas. Extraction surfaces do the same thing. They produce shearing planes when nature and/or tectomechanical stress offers no shearing plane for possible movements.

Both rock bursts in mining and earthquakes and/or seismic vibrations are simply the result of local stress accumulations within the rock, where the structure, including existing changes of the structure of the rock geometry and/or the geometry of the Earth's crust, are contributing factors. For example, it is decisive that rock movements, as a consequence of mining activity, concentrate in areas of tectomechanical destruction because the energy expenditure is lowest there.

In the rock and/or the upper crust of the Earth, no new shearing planes are formed for movements if existing shear planes are available. Stress concentrations therefore tend to occur where a compact rock is present. In this context, the level of destruction of the rock depends on the tectonic elements and their changes. That means that these facts also apply to earthquakes, as well as the reduction of their intensity. The rock geometry and its onset are therefore of essential importance.

### Principles

The principles of the method for prediction of earthquakes and reduction of earthquake intensity by means of stress relief measures come from anthracite coal mining, as well as from natural gas and water extraction (Patent No. EP 760 900, among others). The effects of geopressure and/or differences in geopressure on the economic feasibility of mining and on mine safety were implemented in a comprehensive manner. In the process, it was found that geopressure and geopressure differences are factors that determine and change the energy content within a rock region. Since the reduction of the geopressure depends on rock movements and rock geometry, and at the same time the blocked movement and free movement zones are significant influencing factors, this fact also applies to energy contents. The blocked movement and free movement zones determine the geo-counterpressure and the energy contents, as well as the path of least energy expenditure to reduce the energy content. The surface is therefore significant as a free movement space. With respect to earthquakes, this relates to the maximal energy content in the rock.

For the prevention and reduction of damage from earthquakes and/or seismic vibrations, it is important to observe the boundaries between the rocks masses in and next to which rock movements occur or may occur and those where rock movements are impeded. Based on the geopressure difference method, there are an infinite number of rock masses or geo-blocks that are bounded in some way. The existing shear planes that run into the boundary area overlap in the boundary areas. In rock movements, outrunning shear planes are the reason for notch stresses, which particularly increase the possibility of seismic vibrations.

In the above context, the following is a basis of the method to reduce earthquake intensity by means of stress relief measures:

Pressure is the force that acts on an area. A counterpressure arises there. In rocks and/or the Earth's crust, such areas include tectonic disturbances such as thrust faults, strike slip faults, normal faults, and bedding planes. These elements are in reality interfaces in the rock. The mass of the rock acts as a counterpressure. This applies to both sides of an interface. The geopressure will normally overcome the geo-counterpressure at some point. This may occur on only one or on both sides of a shear plane. The overcoming of a geo-counterpressure is associated with movements. Then no elevation of the stress state relevant to earthquakes and/or seismic vibrations will occur within the rock. New shear planes may be created.

However, if the counterpressure is not overcome, there will be elevated stress in the rock. The case is similar when no geopressure differences are present. In this case, there is no upward shearing in which stresses can be reduced and/or relieved by means of movements. The absence or presence of free movement zones has a comparable effect. That is, free movement zones oppose the blocked movement zones, unless the energy content exceeds the absorption capacity of a rock mass. The energy mass is destroyed, that is, it “bursts.”

The tectonic pressure can then be active over a wide area. In addition, the local components of the geopressure that arise at the site are important, such as those created by movements at the onset and shaping of thrust faults, normal faults, displacements, and upward folding. The overburden pressure of the rock should be mentioned, as the third component.

The above facts distinguish the pressure in the rock or in the Earth's crust from other pressures. The term “geopressure” was therefore created. The geopressure now has different consequences than the pressure above the surface. In this context, the pressure increase, pressure drop, pressure balance, pressure gradients, and pressure changes should be mentioned; these have special effects in the rock or the Earth's crust and lead to movement processes and/or stresses and stress concentrations with various energy contents in the rock masses. In particular, rock is the path of force transmissions.

When used in connection with the rock, the prefix “geo” is added to the above terms, i.e. geopressure increase, geopressure drop, geopressure equilibrium, geopressure differential, and geopressure differences. This has to do with geopressure differences based on the above geopressure (geopressure changes).

A directed variable is created when the geopressure, which is present in a rock section and/or in a section of the Earth's crust, acts as a force upon a surface and therefore on the mass of the rock. The counter-force then arises from the resistance that the mass of the rock exerts. The geopressure is increased at the same time as the resistance. This reaction applies to all interfaces. But geopressure and geo-counterpressure also apply with respect to the folds (saddles). There is an interaction of forces arising from the geopressure that utilize the free movement zones and are held within their boundaries by the blocked movement zones. Thus rock masses occur with different energy contents, whereby the “energy body” may or may not burst. Ultimately, this comes down to rock movements and/or their absence.

The method for reducing the earthquake intensity by means of stress relief measures with allowance for geopressure and geo-counterpressure and their differences includes a classification of the rock masses for seeking and/or determining large rock areas, which are then relieved, or in which the stresses are minimized by means of artificial intervention

The above resistance against geopressure is indeed related to the mass of the rock or large rock blocks, but open spaces in a three dimensional space are also critical for overcoming the geo-counterpressure. They are decisive for possible transformation of forces into rock movements or rock destruction.

The slightest expenditure for movements and movement differences is important in determining the free spaces and their relation to one another. First, the rock movement follows the gravitational forces of the Earth. These generate, as overburden pressure, a geopressure component that increases with depth. If downward movements are impossible, the rock moves to the side. The last option is an upward movement toward the surface. These facts apply to the local regions and their group formation. They apply also to earthquakes and/or seismic vibrations. They are also relevant to the reduction of earthquake intensity by means of stress relief measures, and they apply to earthquakes predictions.

With regard to the surface, in stress relief measures, the focus must be on the path of sub-regions of the rock geometry. The decisive factor here is whether the sub-region is shielded above by other rock and whether a movement downward or sideways would require the lesser amount of energy.

It is a distinctive feature that, similar to rivers meandering between inside and outside banks, the mass of the rock produces or can produce congestion with a ‘geopressure increase.”’ Similarly there is an eddy, a geopressure drop when the advance of the rock and/or the Earth's crust is impossible or impeded. For example, under the aforementioned conditions, geopressure increases or geopressure reductions occur at displacements, normal faults, and thrust faults. At other places, the geopressure remains unaffected by congestion and eddies. Thus geopressure differentials or a geopressure equilibrium is created.

The geopressure equilibrium is the reason for the onset of directed forces. The large scale and local movements, which create the geopressure as such, act together and are indeed supported by the geopressure component that is provided by the overlying rock and which increases with increasing depth. Uneven geopressure equilibrium causes shear planes in the rock, which reduces and/or prevents the onset of stress and therefore seismic vibrations.

It follows from the above that the geopressure has significant effects on the tectomechanical process in the rock. By introduction of the term “geopressure,” this tectomechanical process can be attributed to the components geopressure and geo-counterpressure. This creates a common denominator for reduction of earthquake intensity by means of stress relief measures.

Geopressure differences arise in rocks through the interaction of different movement options at the interfaces of the rock geometry, as well as different movement options in the area of folds and bedding plains and/or on any sliding layers in the Earth's crust. In addition, there is the effect of free-movement spaces on transformation of geo-counterpressure into rock movements. In other words, the geopressure is generated by the mutual interaction of movement options as a whole in connection with the interdependence of tectonic structures and their existing changes in behavior.

The movements within the rock and/or the Earth's crust that are generated by the geopressure and by the geopressure differences generate friction. This involves friction at the interfaces between rock masses that are next to one another or above one another. While at the surface the effects of the friction are limited to the immediate environment of an area, the effects of the geopressure and the thus generated forces are transferred to the interfaces of the larger areas of the rock. This creates friction-induced, discernible areas where the boundaries are based on the results of empirical investigations.

Potential and kinetic geopressure excesses must be combined, whereby kinetic geopressure excesses are generated by high geopressures. That is, analysis of movement processes (movement capacity) is of significant importance. As previously mentioned, not least in this connection, jerky movements must be distinguished from fluid movements. Additional factors are thus created for determining pressure- and/or force transmissions. In this connection, the power source is among other things a restriction of movement processes. The difference of the potentials is thus important (accumulation of pressure increases or accumulation of pressure decreases).

It is also important that geopressure and geopressure differences are closely connected to the possibility of their reduction in the rock. This reduction is achieved through movement processes for which the surface and/or the ocean floor offers significant open spaces. In other words, for the onset of stresses, which in particular cause strong earthquakes and/or seismic vibrations, surface movement processes are worth examining, in order to correlate the generation of stress concentrations as the result of the geopressure and to orient stress relief measures to reduce the earthquake intensity.

The following is important with regard to the above:

Mining has shown that the subsidence and uplift applicable to the rocks, as well as the subsidence slopes, bends, compression, and distractions also apply to the surface, and are also closely related to the stress concentrations in the rocks. It is evident that rock, much like a bimetal, remembers its original condition when reacting to mining activity, for the mining events change the geopressure. Geopressure differences occur as far as the surface as soon as any rock movements are initiated. The rocks and/or the Earth's crust remember their original condition with regard to the effects of the geopressure, as well as with regard to the reduction of earthquake intensity.

This means that if the rock movements follow the gravitational force of the earth or the rock moves to the side as a consequence of geopressure or geopressure differences, or there are upward movements toward the surface, then dependent movements and/or reactions are generated at the surface and/or on the ocean floor. In this way, absent open spaces that are forcibly created with the onset of earthquakes with and without tsunamis can be identified through movement stagnation and arrhythmic movements.

Satellite geodesy, as well as geodesy supported by aerial photography and terrestrial measurements, has been refined to such a degree that the slightest surface movements in both the vertical and horizontal direction can be determined. The changes and to a lesser extent the absolute values are important in determining rock movements as the basis for the occurrence or non-occurrence of earthquakes.

With regard to changes in the region of the ocean floor and/or in coastal areas, volcanic activity is an influencing factor that causes local to large-scale movements in the rock, whereby the horizontal geopressure component is significant for the onset of stress. In other words, the volcanic activity and the movements on the ocean floor outside of the volcanoes are important for the ocean floor and/or the Earth's crust there.

### Technique

Earthquake systematics are influenced both by small units and by their consolidations into larger units or rock masses. That is, rock masses with different rock geometries but comparatively identical influences on earthquake systematics can be consolidated.

The above facts make it vital to have a scale that refers to the size of the rock masses. This creates the foundation for reducing the intensity of earthquakes by targeted measures.

The larger the rock masses in question, the more likely rock movements or their absence will give indications of the earthquake systematics. This means that that ground movements will be examined as the interaction of rock geometries and the size of the rock masses in order to thus obtain a second scale that allows for rock geometry. With regard to earthquake systematics, the rock geometry includes the transition from existing to new rock geometries.

To manage the above earthquake systematics, the determination of ground movements is the basis for the scale that allows for the rock geometries. Satellite systems offer support when the related software is set to examine movements and their absence locally and over wide areas. This creates global data that is the basis for consideration of rock geometries with an eye to reducing the intensity of earthquakes by means of measures that disperse stress concentrations. The same applies to geodesy with regard to aerial surveillance and/or other geodetic measurements.

Furthermore, seismic records provide information on movement processes within the Earth's crust, where these movement processes are also aimed at changes in geometries.

Such seismic waves are always present in the Earth's crust. They are registered by seismographs according to strength and localized in the Earth's crust. The values obtained in this way must be correlated with the movements of the Earth's surface. This creates a further basis for determining the effective geopressure and geo-counterpressure differences.

Indications of blocked movement and free movement zones are also created, for free movement zones are more likely to allow transitions from existing to new rock geometries. Here the rock pressure component associated with the overburden pressure is differentiated. Long-term erosions carry away the ground surface, thus reducing the local overburden pressure over an extended period of time. This can trigger earthquakes because, for the energy content of a certain area, free-movement zones are created that allow jerky movements. The detection of these possibilities with inclusion of comparable rock geometries gives indications of the quantitative significance of the overburden pressure for the aforementioned scale.

The consolidation of small to large units of rock masses allows differentiation within these larger areas with regard to gradation of rock burst hazard and intensity. The small-area detection allows maximum values within the larger areas. This makes it possible to concentrate the stress relief measures on these maximum values. The rock movements in the range of maximum values are mostly impeded by blocked movement zones.

For small-area detection of the maximum values within the larger areas, as well as for evaluation of specific areas, the tectomechanical load and its analysis offer further indications for the aforementioned scale, which helps to grade the rock burst hazard and reduce it by means of technical measures. As in the rock burst patent cited above, rock masses are significant. Tectomechanical analysis allows the determination of shear planes and their network within rock masses. The same applies to determination of rock masses in which the rock is not sheared.

The point of the above is that determination of rock compactness, which is influenced by the changes of the rock mass and/or crust geometry, is very important. Now not only are shearing planes arising due to changes of the deposit geometry important, but the bedding planes as well. Shearing planes as well as bedding planes divide the rock into smaller sections, which then are part of the deposit and/or crust geometry. In this regard, movement potential increases with the increase in shear planes and increase in bedding planes. That is, with respect to the deposit geometry, large sandstone banks and conglomerates as well as sand shale banks, limestone banks, and/or granites etc. must be taken into account.

The above makes it necessary to consider not only the location, the strike, and dip, as well as the fault and/or thrust fault in the rock geometries, but also their changes as elements of rock geometries.

Based on Patent EP 760 900 among others and Patent DE 196 28 367 among others, diverse prerequisites exist in the rocks for the appearance of energy contents.

Blocked movement zones, with respect to ground movements as well as seismic impulses, are characterized by a trend toward lesser changes in the rock geometry and therefore toward lesser movements and/or lesser seismic impulses. On the other hand, the opposite trend exists for free movement zones. These differences are considered in the aforementioned scale, which is compiled for reduction of earthquake intensity based on the changes in the rock geometry.

Blocked movement and free movement zones that are directed toward the surface are of great importance, because the greatest degree of freedom is generally in that direction. There are exceptions, however. The blocked movement zones then ensure that the existing geometry is maintained and/or only slightly modified, and thus that the energy content of the rock is increased. This increase necessarily occurs where the movements necessary to change the rock geometry and thus reduce the energies are impeded.

Blocked movement and free movement zones in the horizontal plane are also important. This is particularly true with regard to plate movements beneath the continents and oceans. The blocked movement and free movement zones are positioned more or less next to another. The same applies with respect to differences within blocked movement and free movement zones. Here again this involves changes in the rock geometries.

In addition there are blocked movement and free movement zones downward, where changes in the rock geometry are also significant.

The change in rock geometry therefore applies to blocked movement and free movement zones. In other words, all rock geometries are significant with regard to earthquakes, with a smaller or larger share in the scale values.

The recognized relations between geopressure, geo-counterpressure, and tectomechanics then provide information about the stress absorption capacity of the rock geometry.

Thus a scale arises that considers the rock geometry and/or crust geometry and at the same time is a basis for predicting earthquakes and for technical measures to reduce the intensity of earthquakes by means of stress relief measures.

This scale is spatially oriented. As mentioned initially, it includes small rock masses and their consolidations into large rock masses. Here the consolidation of the areas into larger units has decisive significance for measures that reduce the intensity of earthquakes. Namely, it ensures that a reduction of stress in one area does not unintentionally increase a hazard in neighboring areas. It is thereby assured that vibration measures such as blasting optimally allow for the changes in the rock geometries with respect to the development of earthquakes.

At the same time, it becomes possible to assess the individual areas by grading the hazard of rock geometries. This assessment can be used more or less globally. This circumstance is comparable with the analysis of the tectomechanics, which likewise relate to the rock geometries and their changes and are globally useable.

Thus tectomechanics in association with the detection of ground movements and seismic signals become the basis for determining the rock geometries and their changes, and hence the basis for the reduction in intensity of earthquakes.

In addition to the above-mentioned movement measurements at the ground surface, as well as the recording of seismic waves and allowance for tectomechanics, magnetic and electric fields, as well as the radon content of ground water, can aid in determining deposit geometries and their changes.

The above information can be used to determine the existing deposit geometry for smaller areas as well as for larger areas. This deposit geometry is acted on by the geopressure, which influences the stresses in the rock. That is, in this regard as well, tectomechanics are of considerable importance. Only in this way can the change potential of the rock and/or crust geometries be put in perspective. The possibility of movements to change the deposit geometry rises and falls with the change potential.

The following influences are significant for the gradations of the above scale:
Ground movements, with allowance for artificial influences such as mining and dams, as well as changes in the rock mass or crust geometries derived from them. Dams produce ground movements that can be measured by technical means.
Seismic impulses and likewise derived changes of rock or crust geometries.
Tectomechanics (as a means of determining the deposit and rock geometries and their changes).

Patent EP 760 900 among others is the basis for this. The patent allows for rock geometries and their changes. This particularly involves the shear planes created during the changes, which turn out to be circulation paths. While in Patent DE 196 28 367, rock compactness is very significant, the shear planes are important for the “gas patent,” and therefore significant for the first scale. Another basis is the “water patent,” DE 103 24 326.7, among others.

This patent likewise allows for the fact that shear planes are created during the changes in rock geometries, which can be systematically determined based on the technical instructions of the patent. This fact is also significant for the first scale.

These influence values exist worldwide. The place and time of development of stress concentrations can be determined for specific regions. It is possible to determine where jerky movements in the crust lead to earthquakes, how stress relief drilling must be oriented, and what the necessary blasting strength must be.

The following suggests itself as a preliminary stage for the scale value of the first scale:

First scale: Block Scale
sheared block 0-1 km³=Scale value 0-1
sheared block 1-10 km³=Scale value 1.1-2
sheared block 10.1-100 km³=Scale value 2.1-3 (at >100 km³=3)
non-sheared block 0-1 km³=Scale value 3.1-4
non-sheared block 1-10 km³=Scale value 4.1-5
non-sheared block 10.1-100 km³=Scale value 5.1-6 (at >100 km³=6)

The scale values are modified by allowing for the compactness of the rock content. The values for layers with very thin banks are multiplied by a factor of 0.1. This factor increases for compact layers up to a value of 1. That means that the above scale value is retained for compact layers.

The rock geometry and/or the crust geometry is taken into consideration when determining the shear planes and/or the energy storage capacity of rock masses, which refers to the “rock burst patent” DE 196 28 367 among others. The changes in the rock geometry and/or the crust geometry have led to already existing shear planes.

The deposit geometry is also important for determining blocked movement and free movement zones. In this context, allowance is made for whether free movement zones have a connection to displacements, that is, thrust faults and/or saddles in the horizontal plane, that is, upward, or normal faults, that is, downward, or no connection to such cross sections in the rock and/or crust. Additionally, the quality and, in this connection, the spatial content of the rock mass that acts as a counterpressure is considered. Free movement zones that have no restrictions, as at the ground surface, are thus assigned a lower multiplier in the described scale. The numbers 0.5-1 are intended as values (for the multiplier), so that the general gradations from 0-6 that characterize the spatial orientation of the rock masses are retained, in order to then determine the orientation and the intensity of the stress relief measures from them.

The technically achievable borehole depths and the effect of a vibration triggered by blasting or the like are of considerable importance for the reduction of the earthquake intensity.

Deep drilling currently reaches a depth of 10-15 km. Added to that is the effect of blasting, whereby nuclear explosions are taken into account, that are effective within a 5 km radius. That means that stress relief measures extend to around 20 km, and scarcely beyond that at present.

### Large-Scale Considerations

The Earth's crust is comprised of a plurality of rock geometries, whose number tends toward infinity, and/or of an infinite number of individual rock masses. The geometries are determined by the position and behavior of thrust faults, displacements, and normal faults, as well as the position and behavior of saddles, depressions, and convex and concave fold axes.

With respect to earthquake hazard, the aforementioned rock geometries are instantaneous conditions in which pressure, forces, and stresses are active. Their significance depends not only on the shear planes, as the consequence of already completed changes in rock geometries, but also on petrography and stratigraphy. That is, the stress absorption capacity of rock masses is of significant importance.

Here the amount of pressure, the direction of the forces, and the stress intensities depend on the addition of tectonic energy, as well as on continuous, jerky, or catastrophic means of reducing this energy. When the energy is reduced, new geometries arise. This has been the case since the creation of the world. That is, the tectonic development of the Earth's crust is a component of earthquake systematics.

This means that the elements of the rock geometry, including their changes, are decisive influencing factor and thus the basis for the stress field and its large-scale detection. The bases are identical to the bases for the first scale (block scale). That is, the following must accordingly be observed for the second scale (group scale):
Ground movements, with allowance for artificial influences such as mining and dams, as well as changes to the rock mass or crust geometries derived from them.
Seismic impulses and likewise derived changes of rock or crust geometries.
Tectomechanics (as a means of determining the deposit and rock geometries and their changes).

This is based on the “rock burst patent,” DE 196 28 367, among others, where rock bursts are associated with deposit and/or rock geometries. It was determined that rock bursts are associated not only with deposit geometries, but in particular with their changes. It was further determined that discernible, tectomechanically induced areas have a significant effect on rock burst systematics. In particular, it was found that the boundaries of these areas have a decisive influence. Since rock bursts and earthquakes are associated with stress release, there are relationships that are useful for the aforementioned scales and therefore for the orientation of the aforementioned measure.

The ground movements as well as the seismic impulses and their localizations provide significant baseline data for the identification of consolidations consisting of individual blocks. Interruptions and/or the absence of ground movements and seismic impulses are significant.

The second scale considers the development of hazardous areas depending on the size and number of associated rock masses. Rock geometries are taken into consideration. The second scale is a group scale, in which the changes of the rock geometries are not yet incorporated. These are taken into account in the third scale (hazard potential scale).

### Second Scale: Group Scale

The individual blocks in the second scale that are consolidated into larger units affect the division of the scale. It is divided into the following groups:

0=0-10 rock masses
1=10-100 rock masses
2=100-1,000 rock masses
3=1,000-10,000 rock masses
4=10,000-100,000 rock masses etc.

Catastrophic reductions arise if stress islands develop in the scope of the change in rock geometry, that is, particularly in areas, where island-like groups of rock geometries and/or blocks are present that lack a continuous or jerky reduction of stress. It is therefore essential to clarify the question of where the concentrations accumulate in such a manner that the requirements for catastrophic pressure reductions gradually develop. Here the decisive influencing factors are the historic development up to the present actual state and the current development process of rock geometries. As mentioned above, the rock remembers the sequence of development conditions.

The development has caused displacements, normal faults, and thrust faults to occur. But it has also caused these disruptive elements to change with regard to strike direction, dips, separation, faulting, and the combining capacity of various tectonic elements.

### Third Scale: Hazard Potential Scale

The potential scale provides information about hazard potential. The first and second scales are the basis for the third scale. The areas where dangerous stress concentrations occur are localized depending on blocked movement and free movement zones and the associated rock masses. The objective is statistical distribution of stress concentrations and their absence. The timeframe for the stress buildup until the subsequent reduction owing to movement processes is significant.

The stress buildup is a spatial phenomenon, while the effects of earthquakes are area oriented, over a period of days. This fact makes it necessary to transfer the spatial orientation from the first and second scale to the surface. This creates a scale that has an area orientation. In other words, the scale allows for spatially determined stresses.

Conforming to the Richter scale, the following gradations arise, which refer to a surface area of 100 km²:
0. Increased stress in 0% of area=No technical measures necessary−no further monitoring
1. Increased stress in 5% of area=No technical measures necessary−no further monitoring
2. Increased stress in 12% of area=No technical measures necessary−no further monitoring
3. Increased stress in 20% of area=No technical measures necessary−monitoring in individual regions necessary
4. Increased stress in 30% of area=No technical measures necessary−comprehensive monitoring necessary
5. Increased stress in 45% of area=No technical measures necessary−comprehensive monitoring
6. Increased stress in 60% of area=Technical measures necessary
7. Increased stress in 80% of area=Technical measures necessary
8. Increased stress in 100% of area=Technical measures urgent

In this regard, the risk is graded by means of the third scale, based on the first and second scale, in order to determine the various geometries on the time axis. Based on this, the time intervals are established in which stress relief measures are implemented in order to convert catastrophic ground movements into jerky ground movements.

Hazard potential charts, which subsequently provide an overview for technical measures, are obtained from the scale contents.

From the above it is clear that the individual mass within the rock geometries plays an important role. Here large-scale examination is significant.

It is essential for these scales that there are infinitely many like groups of rock geometries (second scale). In addition there are their changes (third scale).

Rock and/or crust geometries are determined locally and worldwide. Based on the geometries, the points with increased rock stress due to geopressure, with: allowance for geo-counterpressure, are fitted into the scales 1-3, and the drilling and blasting are oriented in spatial geometry such that the change in the rock geometry (third scale) is continuous or step-wise.

Using these scales, the intensity of blasting is also determined, and indeed with respect both to the rock mass which moves or is supposed to move, and to the rock mass which supplies the geo-counterpressure. The changes of the tectonic geometrical elements and the intensity of the changes, that is, the changes in the extent of faulting, thrust faults, and normal faults, as well as the changes in strikes and dips, are included, and the interdependence of the tectonic structures and their existing changes are taken into account for the orientation of drilling and determination of stress relief measures, and for the type and manner of blasting.

It is the object of the invention to convert catastrophic stress reductions to jerky stress reductions, in order to prevent disastrous damage. This is achieved by orientation of the stress relief measures that are based on the above described scale. In this way, the present rock geometry and the changes in the geometries are taken into consideration. Bore holes are oriented in such a manner that due to vibration blasting and other measures, the existing rock geometry gradually adjusts to the stress buildup, that is, it changes. At the same time the vibrations, that is, the type and manner of blasting, are dosed so that the aforementioned changes arise without producing rock movements that would lead to catastrophic events and/or increase the rock stress in neighboring regions.

By allowance for tectomechanical events, reduction of catastrophic earthquakes to bearable levels on the Richter scale acquires a process-conforming reference base for orienation of bore holes, as well as for orientation of local stress relief measures, and for the type and manner of blasting.

The technical measures of drilling orientation, as well as determination of the stress relief measures, and the type and manner of blasting or other vibrations can be applied to all rock geometries, and thus also to larger units by allowing for the delivery of energy, its reduction, and transmission, as well as for the geo-forces, in terms of direction and effectiveness. To this one must also add allowance for material balances, such as crushing, compression, and loosening, blocked movement and free movement zones in the rock, and material transport, which are also a consequence of the changes in the rock and/or crust geometries.

That is, the changes in the rock geometries and the tectomechanical loads are a significant basis for earthquake systematics. Thus the contents of the rock areas are significant.

Energy, with its supply, reduction, and transmission, is decisive for earthquake systematics. In association with rock geometries, changes in energy flow directions lead to concentrations and/or additions of energy, as well its reduction. Blocked movement and free movement zones are also considered. These are likewise a consequence of rock geometry, that is, the rock geometries may or may not permit movements depending on geopressure. There are therefore energy differences in the rock, whereby the friction resistance on the shear planes of the rock geometries is significant.

These facts are taken into account by means of the above scales 1 to 3, and at the same time the infinite combining possibilities within the rock and crust geometry are reduced to a realistic level. Thus the presence and/or absence of displacements, thrust faults, and normal faults, as well as folds and their infinite combining possibilities become a clearly represented basis for the method for reducing earthquake intensity.

Movement stops also act counter to the movements of continental plates as well as to movements arising from volcanic activity or other movements caused by stress changes in the Earth's crust. The blocked movement zones may act in the direction of the surface, as well as in horizontal and downward directions.

In plate tectonics, the oceanic plates are pushed under the continental plates. This causes earthquakes. Large areas are moved. The earthquake is normally limited to a smaller area, however. That is, areas where larger jerky movements and thus a jerky change in the rock and/or crust geometry occurs. The rock geometries and their changes (third scale) are always the decisive factor and always on the larger scale.

At other places, continental plates push against one another. Different geopressures and different geopressure differences are present, as in the Mediterranean Sea, acting more or less vertically to the continental movement processes. This creates local stress concentrations within a narrow area, whereby the concentrations are associated with larger areas. Here the three scales are applied to determine the hazard potential, and from that the drilling and blasting are oriented.

If the geopressure continuously overcomes the geo-counterpressure, the energy contents are converted into continuous movements, and naturally steadily reduced, and/or the energy body bursts and is destroyed, if the rock is not compact. If there are continuous rock movements as occurs in displacements, smaller earthquakes and/or seismic vibrations occur that are triggered by the mini-movements, or by the bursting of the energy body.

The second and third scales include both the local area and the larger area that is involved in the onset of stress concentrations. The energy in the rock is converted into movement such that no new hazard sources arise.

The global significance of the scales permits continuous adaptation to the realities of processes within the rock geometries. In this regard, the movements that are associated with changes in the rock geometries are accompanied by the registration and assessment of seismic impulses.

### Technical Measures

The vertical and horizontal movements of the Earth's surface measured by technical means and the seismic signals are associated with the rock and/or crust geometries (first and second scale) and their changes (third scale). The third scale is decisive for the orientation of drilling, as well as determination of stress relief measures and the type and manner of blasting.

These facts apply, for example, to the region of the San Andreas Fault. It has displacements and/or a displacement or displacement zone where horizontal movements in particular occur. These movements and their restrictions are connected with the large-scale arrangements of rock geometries and their possibilities for change. The change possibilities are determined with the aid of scales 1-3, and from that the minimum number of bore holes (vertical to horizontal) and blasting actions are determined that would convert jerky movements into more or less continuous ones.

In the above connection, the common basis offered by scales 1-3 for all earthquakes and seismic impulses worldwide can be used by examining the worldwide changes in rock geometries both for the individual rock mass and in the broader context for comparison, and by allowing for the tectomechanical findings. One also determines whether drilling and blasting at other points on the Earth's crust have triggered earthquakes with jerky movements. Tectomechanical analysis of the rock geometries of the Earth's crust is carried out for the technical measures.

Based on an example of use of the invention, in order to obtain and improve the scales, the movements that are detected locally or over a larger area at the ground surface and/or on the ocean floor, as well as seismic waves, are related to the rock geometry and associated movement processes.

According to another example of use of the invention, seismic measurements are taken, and in particular 3D-profiles are created. The structures, which are the cause of onset of stresses and which are described in detail above, are determined. From them, the scale values and/or the stress relief measures to reduce the intensity of earthquakes are oriented.

It is particularly important that not only the first scale, but also the second and third scales be considered, which contain the rock and/or crust geometries that are globally present.

All of the described features, even those that can be found only in the drawings, are considered singly and in combination to be fundamental to the invention.

1. Method for improved prediction and assessment of earthquakes and/or seismic vibrations, whereby the forces, energy contents, and stresses provoked especially at plate boundaries by rock movements, as well as geometrical structures, structural changes of strikes, dips, and the extent of normal and thrust faults and displacements, various tectonic elements with their interdependence, their existing changes from the sudden reduction of stress concentrations within the Earth's crust or based on tectomechanical processes, material balances with loosening, compression, and crushing, as well as rock movements, movement blockage and free zones, and shearing are obtained, wherein the sheared and unsheared rock areas, which are a result of tectomechanical stress and thus a result of the onset of rock geometries, are determined and consolidated into larger units and assigned to a first scale, that the rock and/or crust geometries are determined and consolidated in effect groups in a second scale, that the stress buildup and its relation to the change at the surface is determined, and based on the thus produced third scale, earthquake prophylaxis with predictions of earthquake intensity per area is conducted, and that the scales are gradually adjusted to the determined realities of rock and ground movements, as well as the seismic signals, and that from the content of the scales, hazard potential maps are produced, and hazard potential is combated by means of appropriately targeted stress relief actions.

2. Method according to claim 1, wherein the three-dimensional position changes of the surface and/or the ocean floor are measured by technical means and incorporated in the calculations.

3. Method according to claim 2, wherein the determination is made by satellites and/or aerial surveillance and/or ship-based sonar, or by other geodetic measurements.

4. Method according to claim 2, wherein based on the movements, prophylaxis of the onset or occurrence of earthquakes and/or seismic vibrations is established and used.

5. Method according to claim 1, wherein the movement processes, which are triggered by mining and/or energy or water extraction, are included in the calculations with allowance for rock geometries and their changes.

6. Method according to claim 1, wherein seismic impulses are used to determine the rock geometry and its change, and the measured values are supplemented with information from tectomechanics with respect to determination of the most subtle rock geometries.

7. Method according to claim 6, wherein through tectomechanical analysis, the material balances with crushing, compression, and loosening are obtained and taken into account with respect to all rock geometries.

8. Method according to claim 1, wherein the movement blockage and free zones are determined and considered in the scales.

9. Method according to claim 1, wherein the plate tectonics are taken into consideration.

10. Method according to claim 1, wherein the time intervals are determined.

11. Method according to claim 1, wherein to a large extent all, or at least as many as possible, hazard potentials are included.

12. Method according to claim 1, wherein based on the obtained geometries, the points with increased rock stresses due to geopressure with allowance for geo-counterpressure are fitted into scales 1-3, and the necessary drilling and relief blasting is geometrically oriented.

13. Method according to claim 12, wherein necessary drilling is oriented such that through measured vibration blasting and other stress relief actions, the existing rock geometry gradually adjusts to the stress buildup without generating rock movements and without influencing the rock stress in neighboring areas.

14. Method according to claim 12, wherein groups of bore holes are oriented and drilled into the moving plates.

15. Method according to claim 12, wherein the bore holes are oriented within the effective area of the displacements and the relief blasting is performed at lateral displacements according to its effective radius.

16. Method according to claim 12, wherein the drilling is oriented within the effective area of thrust faults and/or folds.

17. Method according to claim 12, wherein the drilling is oriented within the effective area of normal faults.

18. Method according to claim 17, wherein the drilling is oriented where the normal forces proceeding from the displacements overlap.
